(19) United States
(12) Patent Application Publication
(10) Pub. No.: US 2025/0319867 A1
(43) Pub. Date: Oct. 16, 2025

(54) VEHICLE COLLISION DETERMINATION DEVICE

(71) Applicant: TOYOTA JIDOSHA KABUSHIKI KAISHA, Toyota-shi (JP)

(72) Inventors: Tomoki NAGAO, Nagoya-shi (JP); Hideyuki USUI, Inazawa-shi (JP); Yoshiaki MORiYA, Toyota-shi (JP)

(73) Assignee: TOYOTA JIDOSHA KABUSHIKI KAISHA, Toyota-shi (JP)

(21) Appl. No.: 19/171,563

(22) Filed: Apr. 7, 2025

(30) Foreign Application Priority Data
Apr. 15, 2024 (JP) 2024-065765

(51) Int. Cl. B60W 30/095; B60W 50/00; G06V 20/58

(52) U.S. Cl. CPC B60W 30/0956; B60W 50/0097; G06V 20/58; B60W 2420/403; B60W 2520/10; B60W 2554/402

(57) ABSTRACT

A processor includes: an object probability calculation unit that calculates a first probability that an object in front of the vehicle is a pedestrian or a cyclist; a collision probability calculation unit that calculates a second probability that the vehicle collides with the object; a collision prediction probability calculation unit that calculates a collision prediction probability that is a probability of a collision with the pedestrian or the cyclist based on the first probability and the second probability; a collision determination threshold acquisition unit that acquires a collision determination threshold of the deceleration of the vehicle based on the collision prediction probability; and a collision determination unit that determines whether the vehicle has collided with the pedestrian or the cyclist based on the detection value of the deceleration of the vehicle and the collision determination threshold.

### CROSS-REFERENCE TO RELATED APPLICATION

This application claims priority to Japanese Patent Application No. 2024-065765 filed on Apr. 15, 2024, incorporated herein by reference in its entirety.

### BACKGROUND

### 1. Technical Field

The present disclosure relates to vehicle collision determination devices.

### 2. Description of Related Art

Conventionally, there is known a technique in which a collision with a vulnerable road user is determined to have occurred when deceleration (front Gf) set according to the vehicle speed of a host vehicle becomes greater than a determination threshold within a collision prediction time after a pedestrian or a cyclist is detected as a collision target object (see Japanese Unexamined Patent Application Publication No. 2020-169016 (JP 2020-169016 A)).

### SUMMARY

In the technique described in JP 2020-169016 A, however, it is determined that a collision with a vulnerable road user has occurred when the deceleration become greater than the determination threshold, and this determination is made without considering the probability that the collision target object is a vulnerable road user such as a pedestrian or a cyclist. Therefore, it may be erroneously determined based on, for example, deceleration detected during traveling on a rough road that a collision with a vulnerable road user has occurred, even though a collision with a vulnerable road user has actually not occurred.

The present disclosure provides a vehicle collision determination device that can accurately determine whether a collision with a vulnerable road user has occurred.

The gist of the present disclosure is as follows.

A vehicle collision determination device includes:
an object probability calculation unit configured to calculate a first probability that an object in front of a vehicle is a pedestrian or a cyclist;
a collision probability calculation unit configured to calculate a second probability that the vehicle collides with the object;
a collision prediction probability calculation unit configured to calculate a collision prediction probability based on the first probability and the second probability, the collision prediction probability being a probability that the vehicle collides with the pedestrian or the cyclist;
a collision determination threshold acquisition unit configured to acquire a collision determination threshold of deceleration of the vehicle based on the collision prediction probability; and
a collision determination unit configured to determine whether the vehicle has collided with the pedestrian or the cyclist, based on a detected value of the deceleration of the vehicle and the collision determination threshold.

In the above vehicle collision determination device,
the collision determination threshold acquisition unit may be configured to acquire, based on the collision prediction probability, a map that defines the collision determination threshold according to a vehicle speed, and
the collision determination unit may be configured to check a detected value of the vehicle speed and the detected value of the deceleration of the vehicle against the map and to determine that the vehicle has collided with the pedestrian or the cyclist when the deceleration of the vehicle is greater than the collision determination threshold.

In the above vehicle collision determination device,
the collision determination threshold acquisition unit may be configured to acquire a map in which the collision determination threshold in a low vehicle speed range decreases as the collision prediction probability increases.

In the above vehicle collision determination device,
the collision determination threshold acquisition unit may be configured to acquire a map in which the collision determination threshold in a medium or high vehicle speed range increases as the collision prediction probability decreases.

The present disclosure thus provides a vehicle collision determination device that can accurately determine whether a collision with a vulnerable road user has occurred.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of a vehicle travel assistance system according to an embodiment;

FIG. 2 is a schematic diagram illustrating functional blocks of a processor of an ECU;

FIG. 3 is a flow chart illustrating a process performed by the processor of ECU at predetermined control cycles;

FIG. 4 is a timing chart for explaining an example in which the collision prediction probability calculation unit calculates the level of the collision prediction probability using the control status of PCS control and the collision prediction time TTC;

FIG. 5 is a diagram illustrating an exemplary map acquired by the collision determination threshold acquisition unit based on the collision prediction probability Lv1;

FIG. 6 is a diagram illustrating an exemplary map acquired by the collision determination threshold acquisition unit based on the collision prediction probability Lv2; and

FIG. 7 is a diagram illustrating an exemplary map acquired by the collision determination threshold acquisition unit based on the collision prediction probability Lv3.

### DETAILED DESCRIPTION OF EMBODIMENTS

Hereinafter, some embodiments of the present disclosure will be described with reference to the drawings. However, these descriptions are intended to be merely exemplary of the preferred embodiments of the present disclosure and are not intended to limit the present disclosure to such specific embodiments.

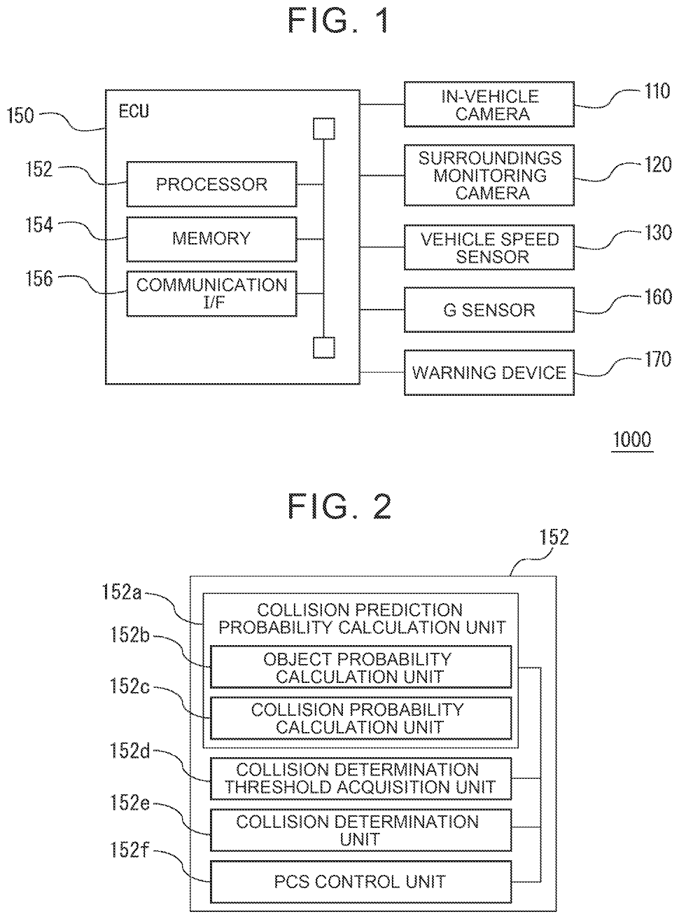

FIG. 1 is a schematic configuration diagram of a driver assistance system 1000 according to an embodiment. The driver assistance system 1000 is mounted on a vehicle such as an automobile. The driver assistance system 1000 includes an in-vehicle camera 110, a surroundings monitoring sensor 120, a vehicle speed sensor 130, an electronic control unit (ECU) 150, a G sensor 160, and a warning device 170. Each of the in-vehicle camera 110, the surroundings monitoring sensor 120, the vehicle speed sensor 130, ECU 150, the G sensor 160, and the warning device 170 is communicably connected via an in-vehicle network. In-vehicle networking complies with standards such as controller area network (CAN).

The in-vehicle camera 110 includes a two-dimensional detector, such as a CCD or a C-MOS, configured by arrays of visible light sensitive photoelectric transducers. The in-vehicle camera 110 has an imaging optical system that forms an image of a region to be imaged on a two-dimensional detector. The in-vehicle camera 110 captures an image of the surroundings of the vehicle (for example, in front of the vehicle) and generates an image representing the environment around the vehicle. The in-vehicle camera 110 may include a front camera, two right and left side cameras, and a rear camera. The in-vehicle camera 110 performs shooting every predetermined shooting cycle (for example, 1/30 seconds to 1/10 seconds). The in-vehicle camera 110 may be constituted by a stereo camera, or may be constituted so as to acquire a distance from the parallax of the left and right images to each structure on the image. Each time an image is generated, the in-vehicle camera 110 outputs the generated image to ECU 150 via the in-vehicle network.

The surroundings monitoring sensor 120 is a sensor for monitoring the surroundings of the vehicle. The surroundings monitoring sensor 120 includes, for example, a sensor such as a light detection and ranging (Lidar) or a radar (Radar). The radar includes a front side radar sensor on the inside of the front bumper and a rear side radar sensor on the inside of the rear bumper. The vehicle speed sensor 130 is a sensor that detects the vehicle speed V of the vehicle.

ECU 150 is an aspect of a collision determination device according to the present disclosure. ECU 150 includes a processor 152, memories 154, and a communication interface 156. The processor 152 has one or more central processing units (CPUs) and its peripheral circuitry. The processor 152 may further include other arithmetic circuits, such as a logical operation unit, a numerical operation unit, or a graphics processing unit. The memory 154 includes, for example, a volatile semiconductor memory and a non-volatile semiconductor memory, and stores data related to the processing according to the present embodiment. The communication interface 156 has interface circuitry for connecting ECU 150 to the in-vehicle networking.

The G sensor 160 outputs a detection signal representing a deceleration (front Gf) of the vehicle caused by a collision with an object in front of the vehicle.

The warning device 170 includes a display device and a speaker. The display device includes, for example, a liquid crystal display (LCD). The warning device 170 is provided in the vicinity of an instrument cluster, a dashboard, or the like. The warning device 170 displays a warning in response to an instruction from ECU 150 and outputs the warning. In response to an instruction from ECU 150, the speaker outputs an alert by sound.

After predicting a collision with a vulnerable road user such as a pedestrian or a cyclist, the driver assistance system 1000 determines that the collision with the vulnerable road user is caused when a predetermined or higher impact (front Gf) is applied to the front portion of the vehicle. Then, the driver assistance system 1000 notifies the center of the emergency notification service of the collision with the vulnerable road user. Examples of the emergency call service include HELPNET, automatic collision notification (ACN), advanced automatic collision notification (AACN), and the like. At this time, the driver assistance device 1000 changes the determination thresholds of the front Gf on the basis of the predicted probability of the collision with the vulnerable road user. This can increase the number of reports of collisions with the vulnerable road user without increasing the number of unnecessary reports to the center of the emergency report service.

FIG. 2 is a schematic diagram illustrating functional blocks of the processor 152 of ECU 150 for realizing the above-described processes. The processor 152 includes a collision prediction probability calculation unit 152a, a collision determination threshold acquisition unit 152d, a collision determination unit 152e, and a PCS control unit 152f. The collision prediction probability calculation unit 152a includes an object probability calculation unit 152b and a collision probability calculation unit 152c. These units included in the processor 152 are, for example, functional modules realized by a computer program running on the processor 152. That is, the functional blocks of the processor 152 are composed of the processor 152 and a program (software) for causing the processor to function. The program may be recorded in the memory 154 of ECU 150 or a recording medium connected from the outside. Alternatively, each of these units included in the processor 152 may be a dedicated arithmetic circuit provided in the processor 152.

The collision prediction probability calculation unit 152a calculates a probability (collision prediction probability) of a collision with a vulnerable road user. Specifically, the object probability calculation unit 152b calculates a first probability that the object in front of the vehicle is a vulnerable road user. In addition, the collision probability calculation unit 152c calculates a second probability that the vehicle collides with the object. Then, the collision prediction probability calculation unit 152a calculates the collision prediction probability based on the first probability and the second probability.

The object probability calculation unit 152b detects the presence of an object in front of the vehicle on the basis of images representing the front of the vehicle generated by the in-vehicle camera 110. At this time, the object is detected from the image by, for example, template matching between the template image and the image generated by the in-vehicle camera 110. Alternatively, an object is detected from an image by inputting an image generated by the in-vehicle camera 110 to an identifier that is machine-learned for object detection.

Note that the object probability calculation unit 152b outputs, as the discriminator, for example, a probability that the object is represented in the pixel for each type of an object that is likely to be represented in the pixel from the inputted image for each pixel of the image. The object probability calculation unit 152b may use a classifier for segmentation learned in advance so as to identify that an object whose probability is maximized is represented. The object probability calculation unit 152b may use a deep neural network (DNN) having a convolutional neural network type (CNN) architecture for segmentation as such a discriminator. CNN is, for example, a fully convolutional network (FCN).

Then, the object probability calculation unit 152b calculates a first probability that the object is a vulnerable road user based on the object detected from the images. The first probability is higher as the object detected from the image is closer to the pedestrian or cyclist. The object probability calculation unit 152b may calculate the first probability by considering the size of the object, the duration in which the object is detected, the presence or absence of other objects close to the object, and the numbers thereof.

The collision probability calculation unit 152c calculates the collision prediction time TTC. The collision prediction time TTC is a prediction time from the current time point until the vehicle collides with the object, and is calculated based on the distance d between the object and the vehicle at the current time point and the relative velocity Vr of the objective collision object with respect to the vehicle. Specifically, TTC=d/Vr. The collision prediction time TTC is used as an index indicating a height of a possibility that the own vehicle collides with an object, and the smaller the value, the higher the possibility that the vehicle collides with the object. The collision prediction time TTC changes from moment to moment. Then, the collision probability calculation unit 152c calculates the second probability based on the position of the object obtained from the images generated by the in-vehicle camera 110, the collision prediction time TTC, the presence or absence of the avoidance of the object by the drivers of the vehicles, and the like. The second probability is higher as the position of the object is closer to the vehicle, the smaller the collision prediction time TTC is, and the smaller the driver's avoidance manipulation is, the higher the probability is.

The collision determination threshold acquisition unit 152d acquires the collision determination threshold Gfref of the deceleration of the vehicle based on the collision prediction probability calculated by the collision prediction probability calculation unit 152a. The collision determination threshold acquisition unit 152d may acquire a map defining a collision determination threshold Gfref corresponding to the vehicle speed based on the collision prediction probability. The collision determination threshold acquisition unit 152d may acquire a map in which the collision determination threshold Gfref in the low vehicle speed range is smaller as the collision prediction probability is higher. Further, the collision determination threshold acquisition unit 152d may acquire a map in which the collision determination threshold Gfref in the medium or high vehicle speed range is larger as the collision prediction probability is lower. These maps may be stored in ECU 150 memories 154.

The collision determination unit 152e determines whether or not the vehicle has collided with the vulnerable road user based on the detected value of the deceleration of the vehicle and the collision determination threshold Gfref. The collision determination unit 152e may check the detected values of the vehicle speed and the deceleration of the vehicle against the map acquired by the collision determination threshold acquisition unit 152d, and may determine that the vehicle has collided with the vulnerable road user when the deceleration of the vehicle is larger than the collision determination threshold Gfref.

PCS control unit 152f performs collision avoidance support control (pre-crash safety control, hereinafter referred to as PCS control). PCS control includes outputting an alarm sound or an alarm indication from the warning device 170, and controlling the pre-crash brake assist or the pre-crash brake.

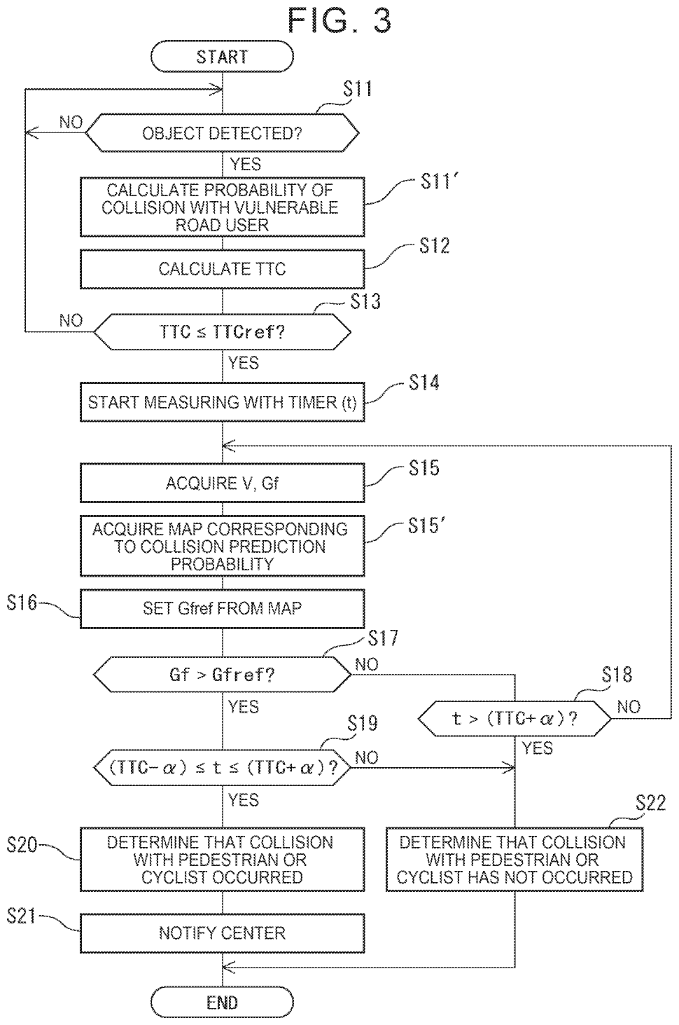

FIG. 3 is a flow chart showing a process performed by the processor 152 of ECU 150 for each predetermined control cycle. In FIG. 3, processing other than S11′ and S15′ may be performed in the same manner as the processing described in JP 2020-169016 A described above. Similar to JP 2020-169016 A, in the process of FIG. 3, if the collision prediction timing determined from the collision prediction time TTC of the object and the timing at which the front Gf exceeds the collision determination threshold Gfref are at the same time, it is estimated that the vehicle collides with the object. The timing at which the front Gf exceeds the collision determination threshold Gfref is the actual detection timing.

First, the object probability calculation unit 152b determines whether or not an object in front of the vehicle is detected from the images generated by the in-vehicle camera 110 (S11). When the object is detected, the collision prediction probability calculation unit 152a calculates the probability of a collision with the vulnerable road user, that is, the collision prediction probability (S11′). On the other hand, when the object is not detected by S11, the process returns to S11.

After S11′, a collision prediction time TTC is calculated (S12). The collision prediction time TTC is constantly calculated by the collision probability calculation unit 152c. Next, it is determined whether the collision prediction time TTC is equal to or less than the threshold TTCref (S13). When the collision prediction time TTC is equal to or less than the threshold TTCref, the timer starts measuring a timer value t (S14). On the other hand, if the collision prediction time TTC exceeds the threshold TTCref, the process returns to S11.

After S14, the vehicle speed V detected by the vehicle speed sensor 130 and the front Gf detected by the G sensor 160 are acquired (S15). Next, the collision determination threshold acquisition unit 152d acquires, from among the plurality of collision determination threshold maps defining the collision determination threshold Gfref corresponding to the vehicle speed V, a map corresponding to the probability of a collision with the vulnerable road user, that is, the collision prediction probability (S15′).

Next, the collision determination thresholds Gfref corresponding to the vehicle speed V are set by referring to the map acquired by S15′ (S16). Next, it is determined whether the front Gf detected by the G sensor 160 is greater than the collision determination threshold Gfref (S17). If the front Gf is greater than the collision determination threshold Gfref, it is determined whether the timer value t is a value within the object collision predicted allowable time (S19). Note that the object collision prediction allowable period is a period between TTC−α and TTC+α, and a is an error allowable value. On the other hand, if the front Gf is equal to or less than the collision determination threshold Gfref, it is determined whether or not the timer t is greater than the determination end time (TTC+α) (S18). If the timer t is less than or equal to the determination end time (TTC+α), the process returns to S15.

In S19, when the timer value t is a value within the object collision prediction allowable period, that is, when the collision prediction timing and the actual detection timing are at the same time, it is ensured that the front Gf is caused by the collision with the object. The collision prediction timing is determined from the collision prediction time TTC. The actual detection timing is a timing at which the front Gf exceeds the collision determination threshold Gfref. Therefore, the collision determination unit 152e determines that the vehicle has collided with the vulnerable road user (S20). Next, the collision occurrence information is provided to the emergency call service center (S21). After S21, the process ends.

On the other hand, in S19, when the timer value t is not a value within the object collision prediction allowable period, the collision determination unit 152e determines that the collision is not a collision between the vehicle and the vulnerable road user (S22).

In addition, in S18, if the timer t exceeds the determination end time (TTC+α) while the front Gf is not larger than the collision determination threshold Gfref, the collision determination unit 152e determines that the vehicle is not colliding with the vulnerable road user (S22). After S22, the process ends.

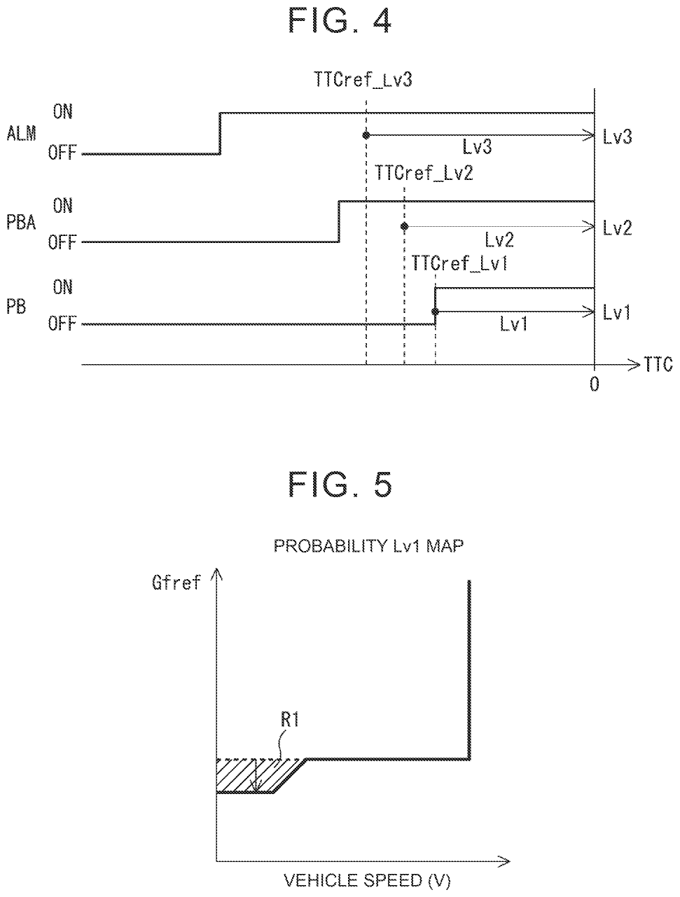

FIG. 4 is a timing chart illustrating an example in which the collision prediction probability calculation unit 152a calculates the level of the collision prediction probability by using the control status of PCS control and the collision prediction time TTC. FIG. 4 shows a state at a timing earlier than the collision prediction time (TTC=0). FIG. 4 shows how the alarm (ALM), the pre-crash brake assist (PBA), and the pre-crash brake (PB) operate in this order as the collision prediction time TTC approaches zero. In this case, it is determined by the object probability calculation unit 152b that the first probability that the object is the vulnerable road user is equal to or greater than a certain value, and it is highly likely that the object is a vulnerable road user. Therefore, the level of collision prediction probability is mainly determined by the second probability of collision with the object calculated by the collision probability calculation unit 152c.

In the exemplary embodiment illustrated in FIG. 4, the higher the probability of the operation of PCS, the larger the collision prediction probability is. The probability with which PCS operates is highest when the pre-crash brake (PB) is turned on, higher when the pre-crash brake assist (PBA) is turned on, and lowest when the alarm (ALM) is turned on. In addition, the probability that PCS will operate increases as the collision prediction time TTC becomes shorter.

As shown in FIG. 4, the pre-crash brake (PB) is activated when the collision prediction time TTC reaches the collision determination thresholds TTCref_Lv1. When the pre-crash brake (PB) is activated, the collision prediction probability calculation unit 152a calculates a Lv1 as the collision prediction probability.

The pre-crash brake assist (PBA) assists the braking force when the driver depresses the brake pedal. Even when the pre-crash brake assist (PBA) is turned on, the assist is not performed unless the driver depresses the brake pedal. When the pre-crash brake assist (PBA) is turned on and the collision prediction time TTC reaches the collision determination thresholds TTCref_Lv2, the collision prediction probability calculation unit 152a calculates a Lv2 as the collision prediction probability.

Further, the collision prediction probability calculation unit 152a calculates Lv3 as the collision prediction probability when the alarm (ALM) is turned on and the collision prediction time TTC reaches the collision determination threshold TTCref_Lv3.

As described above, the collision prediction probability calculation unit 152a can calculate the collision prediction probabilities Lv1, Lv2, Lv3 based on the control status of PCS and the collision prediction time TTC. Note that there is a relationship of Lv1>Lv2>Lv3.

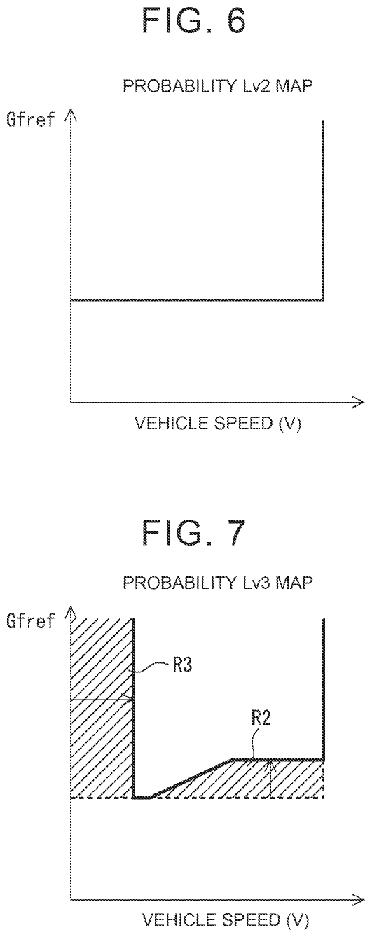

FIGS. 5 to 7 are diagrams illustrating examples of maps acquired by the collision determination threshold acquisition unit 152d based on the collision prediction probabilities Lv1, Lv2, Lv3. The maps shown in FIGS. 5 to 7 define Gfref of the collision determination threshold of the front Gf corresponding to the vehicle speed V. Of these, the map shown in FIG. 6 is a map acquired when the collision prediction probability is Lv2, and the collision determination threshold Gfref is a fixed value that does not change according to the vehicle speed V.

In the map shown in FIG. 6, in order to avoid erroneous determination, the collision determination thresholds Gfref are large enough to prevent erroneous determination from occurring. The erroneous determination is that the front Gf detected by the G sensor 160 is erroneously determined as a collision with a vulnerable road user during a rough road or a light collision.

On the other hand, the map illustrated in FIG. 5 is a map acquired when the collision prediction probability is Lv1. In the map shown in FIG. 5, the collision determination thresholds Gfref of the map shown in FIG. 6 are lowered so that collisions with the vulnerable road user can be detected more in the area of the low vehicle speed and the low front Gf when collisions with the vulnerable road user occur frequently. Thus, in the map shown in FIG. 5, a region in which a collision with a vulnerable road user is determined is increased in the hatched area R1 compared with the map shown in FIG. 6.

FIG. 5 is a map obtained when the collision prediction probability is lower than that of FIG. 6. When the collision determination thresholds Grief is lowered as shown in FIG. 6, the front Gf detected during traveling on a rough road or the light collision is likely to be erroneously determined as a collision with a vulnerable road user. As a result, there is a high probability that unnecessary information other than a collision with a vulnerable road user is detected. Since the area R1 is an area in which collision with a vulnerable road user occurs particularly frequently, according to the map of FIG. 6, when the collision prediction probability is high, it is possible to determine more collisions with a vulnerable road user that could not be detected in the map of FIG. 5.

The map illustrated in FIG. 7 is a map acquired when the collision prediction probability is Lv3. In the map shown in FIG. 7, the collision determination thresholds Gfref are increased in the medium or high vehicle speed range and in the region of the high front Gf. As a result, the area to be determined as a collision with a vulnerable road user is reduced by the hatched area R2.

If the map shown in FIG. 5 is used when the collision prediction probability is low, even if the front Gf exceeds the collision determination thresholds Gfref in the medium or high vehicle speed range, the probability that the object is a vulnerable road user is low. Therefore, there are many cases where it is erroneously determined that the vehicle collides with a vulnerable road user due to front Gf such as when traveling on a rough road. According to the map of FIG. 7, when the collision prediction probability is low, the collision determination threshold Gfref is increased in the medium or high vehicle speed range, so that it is suppressed that the front Gf detected during the rough road traveling or the light collision is erroneously determined as a collision with a vulnerable road user.

In addition, when the collision prediction probability is low, in particular, in the area R3 of the low vehicle speed, the frequency of occurrence of collision with a vulnerable road user is low. Therefore, in the map shown in FIG. 7, the collision with a vulnerable road user is not determined even in the area R3 of the low vehicle speed.

When the collision prediction probability is low and the front Gf exceeds the collision determination threshold Gfref shown in FIG. 7 in the medium or high vehicle speed range, it is estimated that the impact is large in the collision with a vulnerable road user. According to the map of FIG. 7, it is possible to detect a collision with a vulnerable road user having such a large impact while reducing the possibility that the front Gf detected during traveling on a rough road etc. is erroneously determined to be a collision with a vulnerable road user.

As described above, according to the maps shown in FIGS. 5 to 7, it is possible to prevent an erroneous determination of a collision with a vulnerable road user due to a front Gf such as when traveling on a rough road, and it is possible to suppress a frequency at which an unnecessary notification is made to the center of the emergency notification service. The detection rate of the collision with a vulnerable road user can be improved in the region of the low vehicle speed range and the low front Gf in which the collision frequency with a vulnerable road user is high, and in the region of the medium and high vehicle speed ranges and the high front Gf. As a result, it is possible to improve the accuracy of the notification to the center of the emergency notification service.

As described above, according to the present embodiment, by changing the collision determination thresholds Gfref based on the collision prediction probability which is the probability of a collision with a vulnerable road user, erroneous determination is suppressed from occurring in the determination of collision with a vulnerable road user.

What is claimed is:

1. A vehicle collision determination device comprising:
an object probability calculation unit configured to calculate a first probability that an object in front of a vehicle is a pedestrian or a cyclist;
a collision probability calculation unit configured to calculate a second probability that the vehicle collides with the object;
a collision prediction probability calculation unit configured to calculate a collision prediction probability based on the first probability and the second probability, the collision prediction probability being a probability that the vehicle collides with the pedestrian or the cyclist;
a collision determination threshold acquisition unit configured to acquire a collision determination threshold of deceleration of the vehicle based on the collision prediction probability; and
a collision determination unit configured to determine whether the vehicle has collided with the pedestrian or the cyclist, based on a detected value of the deceleration of the vehicle and the collision determination threshold.

2. The vehicle collision determination device according to claim 1, wherein:
the collision determination threshold acquisition unit is configured to acquire, based on the collision prediction probability, a map that defines the collision determination threshold according to a vehicle speed; and
the collision determination unit is configured to check a detected value of the vehicle speed and the detected value of the deceleration of the vehicle against the map and to determine that the vehicle has collided with the pedestrian or the cyclist when the deceleration of the vehicle is greater than the collision determination threshold.

3. The vehicle collision determination device according to claim 2, wherein the collision determination threshold acquisition unit is configured to acquire a map in which the collision determination threshold in a low vehicle speed range decreases as the collision prediction probability increases.

4. The vehicle collision determination device according to claim 2, wherein the collision determination threshold acquisition unit is configured to acquire a map in which the collision determination threshold in a medium or high vehicle speed range increases as the collision prediction probability decreases.
